(19) United States
(12) Patent Application Publication
(10) Pub. No.: US 2023/0281099 A1
(43) Pub. Date: Sep. 7, 2023

(54) USER-IMPACT INDEX FOR APPLICATIONS SERVING USERS

(71) Applicant: Healtech Software India Pvt. Ltd., Bangalore (IN)

(72) Inventors: Raja Shekhar Mulpuri, Bangalore (IN); Jaisri S, Bangalore (IN); Rashmi MS, Bangalore (IN)

(21) Appl. No.: 18/179,402

(22) Filed: Mar. 7, 2023

(30) Foreign Application Priority Data
Mar. 7, 2022 (IN) 202241012160

(51) Int. Cl. G06F 11/34; G06F 11/07

(52) U.S. Cl. CPC G06F 11/3409; G06F 11/0769; G06F 11/0721

(57) ABSTRACT

According to an aspect, metrics of an application are measured, the measured metrics including a first metric and a second metric, the first metric representing a measure of the responsiveness of the application when processing user requests received from users, and the second metric representing a measure of the responsiveness to resolution of problems identified in the application. A single number is calculated based on the metrics including the first metric and the second metric. The calculated single number is provided (to a user) as representing a user impact index for the application. Thus, the user impact index provided captures both the responsiveness of the application when processing user requests and the responsiveness to resolution of problems identified in the application.

### PRIORITY CLAIM

The instant patent application is related to and claims priority from the co-pending India provisional patent application entitled, “USER-IMPACT INDEX FOR APPLICATIONS SERVING USERS”, Serial No.: 202241012160, Filed: 7 Mar. 2022, which is incorporated in its entirety herewith.

### BACKGROUND OF THE DISCLOSURE

### Technical Field

The present disclosure relates to application servers and more specifically to user-impact index for applications serving users.

### Related Art

Applications generally receive requests and generate corresponding responses in serving users. In complex environments, users are impacted by various aspects such as availability of computing power, storage capacity, network bottlenecks, in addition to factors such as design flaws and application crashes, etc.

At least to have a numerical understanding of the extent of impact to users, there is a general need to provide user-impact indexes in relation to applications serving users.

### BRIEF DESCRIPTION OF THE DRAWINGS

Example embodiments of the present disclosure will be described with reference to the accompanying drawings briefly described below.

FIG. 1 is a block diagram illustrating an example environment in which several aspects of the present disclosure can be implemented.

FIG. 2 is a flow chart illustrating the manner in which a user-impact index for applications serving users is calculated according to aspects of the present disclosure.

FIG. 3A depicts the components of a software application in one embodiment.

FIG. 3B illustrates an example state of a node in a cloud infrastructure.

FIG. 3C illustrates the manner in which multiple clouds (and correspondingly software applications) are hosted in a cloud infrastructure in one embodiment.

FIG. 3D depicts the manner in which components of a software application are deployed in a cloud in one embodiment.

FIGS. 4A and 4B together depicts the various metrices based on which a user impact index is computed according to several aspects of the present disclosure.

FIGS. 5A-5B illustrate example calculations performed for calculating a user impact index for an application.

FIG. 6 is a block diagram illustrating the details of digital processing system (800) in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides user-impact index for applications serving users. In one embodiment, metrics of an application are measured, the measured metrics including a first metric and a second metric, the first metric representing a measure of the responsiveness of the application when processing user requests received from users, and the second metric representing a measure of the responsiveness to resolution of problems identified in the application. A single number is calculated based on the metrics including the first metric and the second metric. The calculated single number is provided (to a user) as representing a user impact index for the application.

Thus, the user impact index provided captures both the responsiveness of the application when processing user requests and the responsiveness to resolution of problems identified in the application.

According to another aspect of the present disclosure, a first value for the user impact index indicates that the extent of impact of the application on the users is most desirable, and a second value for the user impact index indicates that the extent of impact of the application on the users is least desirable, wherein the first value is different significantly from the second value with intermediate values reflecting corresponding degree of desirability of impact.

According to one more aspect of the present disclosure, the single number is calculated to be close to the first value when both the responsiveness of the application when processing user requests and the responsiveness to resolution of problems are high. The single number is calculated to be close to the second value when both the responsiveness of the application when processing user requests and the responsiveness to resolution of problems are low.

According to yet another aspect of the present disclosure, the measured metrics includes responsiveness metrics (such as the first metric noted above) and problem resolution metrics (such as the second metric noted above). The calculation of the single number is performed by quantifying each metric by a respective observability index, determining a core product impact index as a first function of the respective observability index for responsiveness metrics, and a customer commitment index as the first function of the respective observability index for problem resolution, and computing the single number as a second function of the core product impact index and the customer commitment index. In one embodiment, the first function is arithmetic mean and the second function is harmonic mean.

According to an aspect of the present disclosure, quantifying each metric uses a continuous function of the weighted values of the metric. The weights for a responsiveness metric are ratios of the number of transactions of a transaction type of a value to the total number of transactions in a fixed duration. The weights for a problem resolution metric represent one or both of a priority and a severity of a problem identified in said application.

In one embodiment, the responsiveness metrics include transaction response time of the application, availability of the application, screen rendering time, page loading time, application crashes, and start-up times of the application. The problem resolution metrics include time to respond to a problem ticket raised by a user, and resolution time of a problem ticket.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

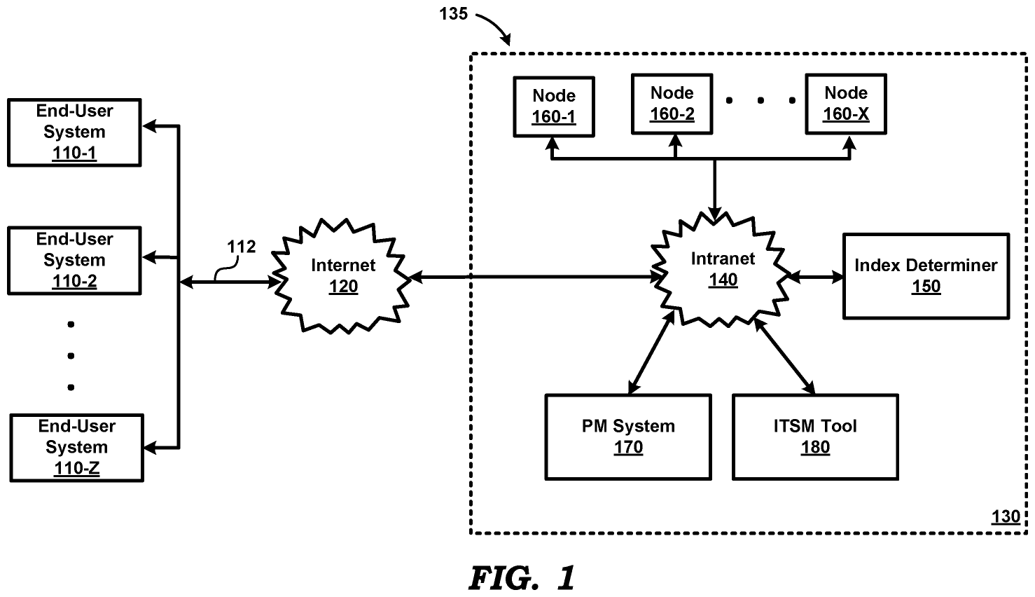

FIG. 1 is a block diagram illustrating an example environment in which several aspects of the present disclosure can be implemented. The block diagram is shown containing end-user systems 110-1 through 110-Z (Z representing any natural number), Internet 120, and computing infrastructure 130. Computing infrastructure 130 in turn is shown containing intranet 140, index determiner 150, nodes 160-1 through 160-X (X representing any natural number), PM (performance management) system 170 and ITSM (IT Service Management) tool 180. The end-user systems and nodes are collectively referred to by 110 and 160 respectively.

Merely for illustration, only representative number/type of systems are shown in FIG. 1. Many environments often contain many more systems, both in number and type, depending on the purpose for which the environment is designed. Each block of FIG. 1 is described below in further detail.

Computing infrastructure 130 is a collection of nodes (160) that may include processing nodes, connectivity infrastructure, data storages, administration systems, etc., which are engineered to together host software applications. Computing infrastructure 130 may be a cloud infrastructure (such as Amazon Web Services (AWS) available from Amazon.com, Inc., Google Cloud Platform (GCP) available from Google LLC, etc.) that provides a virtual computing infrastructure for various customers, with the scale of such computing infrastructure being specified often on demand.

Alternatively, computing infrastructure 130 may correspond to an enterprise system (or a part thereof) on the premises of the customers (and accordingly referred to as “On-prem” infrastructure). Computing infrastructure 130 may also be a “hybrid” infrastructure containing some nodes of a cloud infrastructure and other nodes of an on-prem enterprise system.

All the nodes (160) of computing infrastructure 130, index determiner 150, PM system 170 and ITSM tool 180 are connected via intranet 140. Internet 120 extends the connectivity of these (and other systems of the computing infrastructure) with external systems such as end-user systems 110. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Each of end-user systems 110 represents a system such as a personal computer, workstation, mobile device, computing tablet etc., used by users to generate (user) requests directed to software applications executing in computing infrastructure 130. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system requests a software application for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or software application, with the IP packet including data identifying the desired tasks in the payload portion.

Some of nodes 160 may be implemented as corresponding data stores. Each data store represents a non-volatile (persistent) storage facilitating storage and retrieval of data by software applications executing in the other systems/nodes of computing infrastructure 130. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 160 may be implemented as corresponding server systems. Each server system represents a server, such as a web/application server, constituted of appropriate hardware executing software applications capable of performing tasks requested by end-user systems 110. A server system receives a user request from an end-user system and performs the tasks requested in the user request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting end-user system (one of 110) as a corresponding response to the user request. The results may be accompanied by specific user interfaces (e.g., web pages) for displaying the results to a requesting user.

In one embodiment, each customer/tenant is provided with a corresponding virtual computing infrastructure (referred to as a “cloud”) hosted on nodes 160 of cloud infrastructure 130. Each customer may host desired software applications/data services on their cloud(s), which are capable of processing user requests received from end-user systems 110. Examples of such software applications include, but are not limited to, data processing (e.g., batch processing, stream processing, extract-transform-load (ETL)) applications, Internet of things (IoT) services, mobile applications, and web applications.

In the following description, computing infrastructure 130 along with the software applications deployed therein are together viewed as a computing environment (135). It may be appreciated that the processing of user requests received from end user systems 110 causes resources to be consumed/used in computing environment 135. As the resources in computing environment are limited, it may be desirable to monitor and manage the resources consumed by computing infrastructure 130.

### 3. Management of Resources in Computing Environment

PM (performance management) system 170 aids in the management of the performance of computing environment 135, in terms of managing the various resources noted above. Broadly, PM system 170 is designed to process time series of values of various data types characterizing the operation of nodes 160 while processing user requests. The data types can span a variety of data, for example, performance metrics (such as CPU utilization, memory used, storage used, etc.), logs, traces, topology, etc. Based on processing of such values of potentially multiple data types, PM system 170 predicts expected values of performance metrics of interest at future time instances. PM system 170 also identifies potential issues (shortage of resources, etc.) in computing environment 135 based on such predicted expected values and/or actual values received from nodes 160 and triggers corresponding alerts for the identified issues.

In one embodiment, PM system 170 uses ML (machine learning) based or DL (deep learning) based approaches for co-relating the performance metrics (with time instances or user requests received from end user system 110) and predicting the issues/violations for the performance metrics. Examples of machine learning (ML) approaches are KNN (K Nearest Neighbor), Decision Tree, etc., while deep learning approaches are Multilayer Perceptron (MLP), Convolutional Neural Networks (CNN), Long short-term memory networks (LSTM) etc. Such PM systems that employ AI (artificial intelligence) techniques such as ML/DL for predicting the outputs are also referred to as AIOps (AI for IT operations) systems.

ITSM (IT Service Management) tool 180 facilitates IT managers such as administrators, SREs (Site Reliability Engineers), etc. to provide end-to-end delivery of IT services (such as software applications) to customers. To facilitate such delivery, ITSM tool 180 receives the alerts/incidents triggered by PM system 170 and raises corresponding problem tickets/incident reports for the attention of the IT managers. In addition, users using end-user systems 110 may manually raise/submit problem tickets to ITSM tool 180. ITSM tool 180 may maintain the raised problem tickets in a non-volatile storage such as a data store (e.g., one of nodes 160). Examples of ITSM tool 180 are ServiceNow software available from ServiceNow[R], Helix ITSM (previously Remedy ITSM) software available from BMC Software, Inc, etc.

It may be appreciated that users using end user systems 110 are impacted by various aspects such as availability of computing power, storage capacity, network bottlenecks, etc. (in general, resources) in addition to factors such as design flaws and application crashes, etc. which are identified by PM system 170 and raised as problem tickets in ITSM tool 180. As noted in the Background section, there is a general need to provide a numerical/quantifying understanding of the extent of impact of such aspects to users of software applications.

Index determiner 150, provided according to several aspects of the present disclosure, computes a user-impact index for applications (deployed in computing environment 135) serving users (using end user systems 110). Though shown internal to computing infrastructure 130, in alternative embodiments, index determines 150 may be implemented external to computing infrastructure 130, for example, as a system connected to Internet 120. The manner in which index determiner 150 computes user-impact index is described below with examples.

### 4. Calculating User-Impact Index for Applications Serving Users

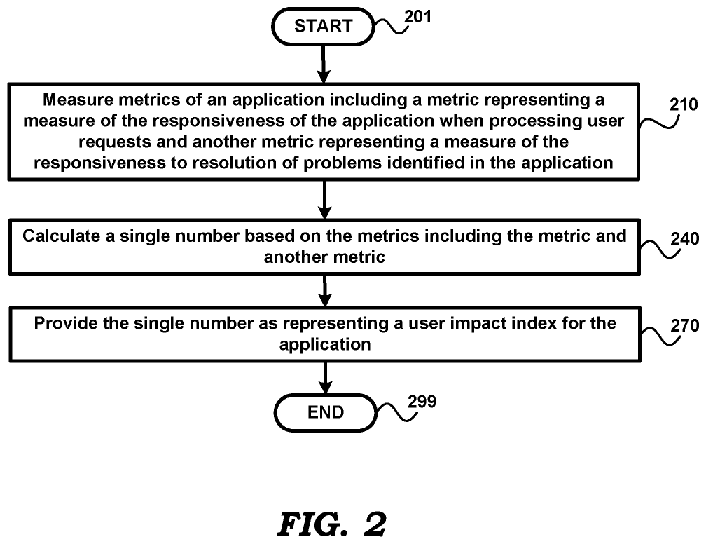

FIG. 2 is a flow chart illustrating the manner in which a user-impact index for applications (deployed in computing environment 135) serving users (using end user systems 110) is calculating according to aspects of the present disclosure. The flowchart is described with respect to the systems of FIGS. 1, in particular index determiner 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, index determiner 150 measures metrics of an application (hosted in computing environment 135) including a metric representing a measure of the responsiveness of the application when processing user requests (received from end-user systems 110) and another metric representing a measure of the responsiveness to resolution of problems identified in the application.

The measurement of responsiveness of an application may be performed by processing the performance metrics (and other data types) received from nodes 160 (or PM system 170), while the measurement of responsiveness of resolution of problems may be performed by interfacing with ITSM tool 180.

According to an aspect, the measured metrics are grouped into responsiveness metrics that measure the responsiveness of the application when processing user requests and problem resolution metrics that measure the responsiveness to resolution of problems identified in the application. Examples of responsiveness metrics include but not limited to transaction response time of said application, availability of said application, screen rendering time, page loading time, application crashes, and start-up times of said application. Examples of problem resolution metrics include but not limited to time to respond to a problem ticket raised by a user, and resolution time of a problem ticket.

In step 240, index determiner 150 calculates a single number based on the metrics including the metric and another metric. The calculation may be performed in any convenient manner. According to an aspect, the calculation is performed by first quantifying each measured metric by a respective observability index, determining a core product impact index as a first function of the respective observability index for responsiveness metrics, and a customer commitment index as the first function of the respective observability index for problem resolution metrics and computing the single number as a second function of the core product impact index and the customer commitment index. In one embodiment, the first function is arithmetic mean and the second function is harmonic mean.

In step 270, index determiner 150 provides the single number as representing a user impact index for the application. The user impact index indicates the extent of impact of the application on the users using end-user systems 110. According to an aspect, a first value for the user impact index indicates that the extent of impact of the application on the users is most desirable, and a second value for the user impact index indicates that the extent of impact of the application on the users is least desirable, the first value being different significantly from the second value. The intermediate values between the first value and the second value reflects corresponding degree of desirability of impact.

It may be appreciated that any desired combination of first value and second value may be chosen based on the computing environment. For example, the first value may be chosen to be a large value (e.g. 100) to indicate most desirable while the second value is chosen to be a small value (e.g. 1) to indicate least desirable. Alternatively, the first value and the second value may be chosen to be a small value (e.g. 0) and a large value (e.g. 1) respectively, with the small value indicating most desirable.

According to an aspect, the single number/user impact index is calculated to be close to the first value when both the responsiveness of the application when processing user requests and the responsiveness to resolution of problems are high. The single number is calculated to be close to the second value when both the responsiveness of the application when processing user requests and the responsiveness to resolution of problems are low. Control passes to step 299, where the flowchart ends.

Thus, index determiner 150 computes a user-impact index for applications (deployed in computing environment 135) serving users (using end user systems 110). The manner in which index determiner 150 provides several aspects of the present disclosure according to the steps of FIG. 2 is described below with examples.

### 5. Illustrative Example

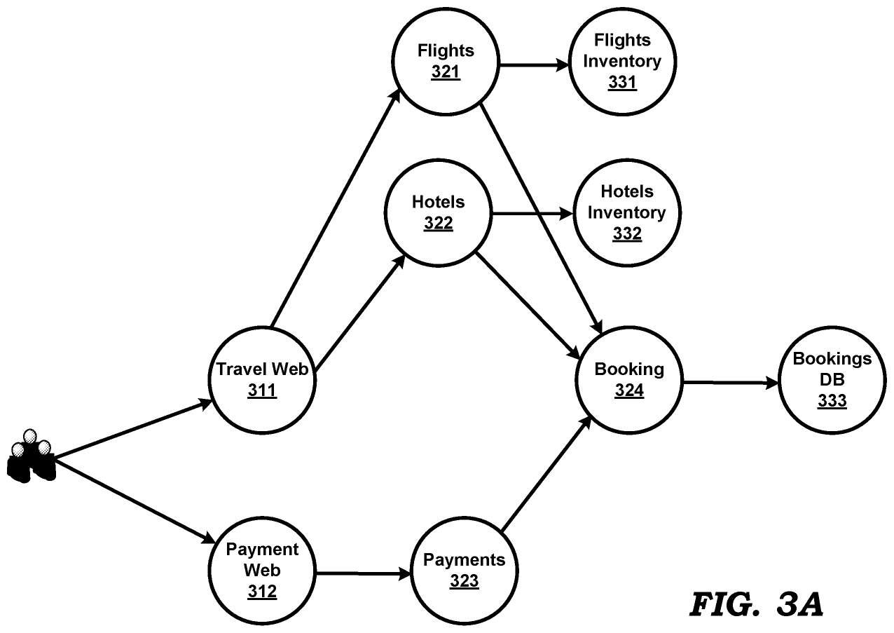

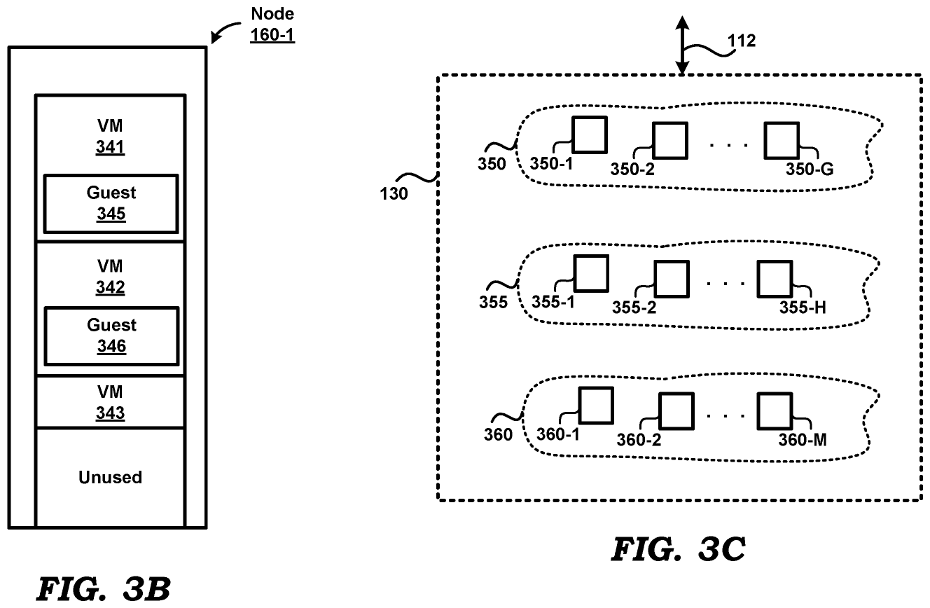

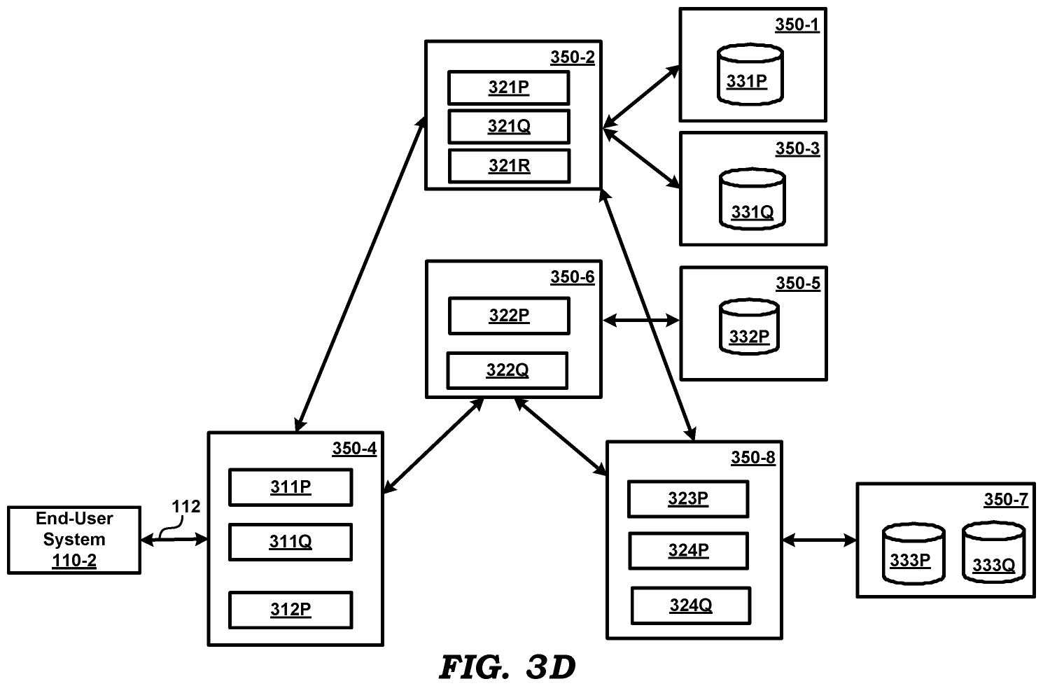

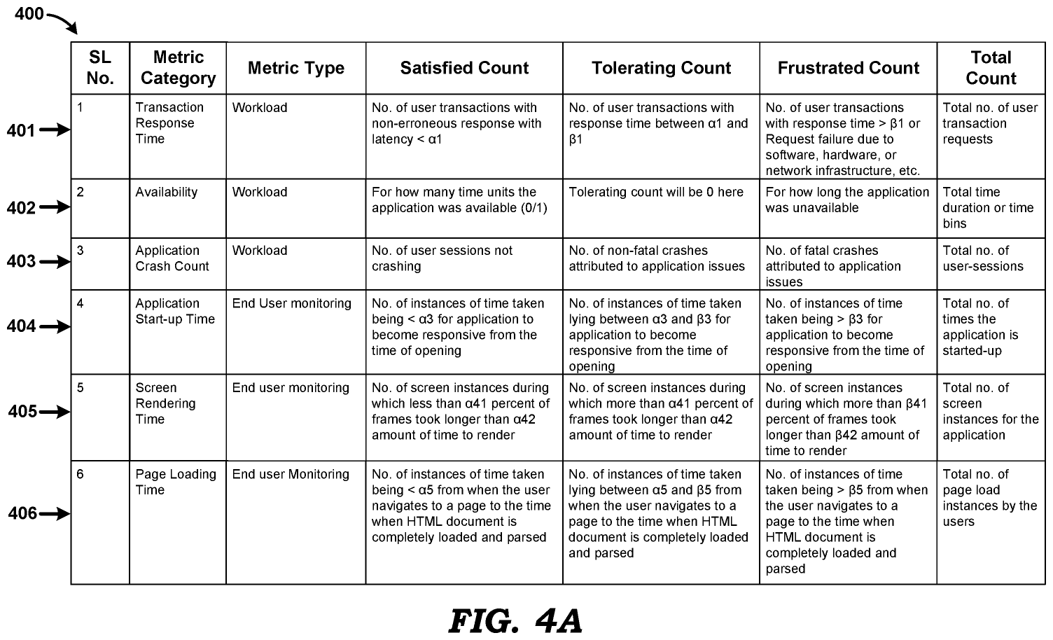

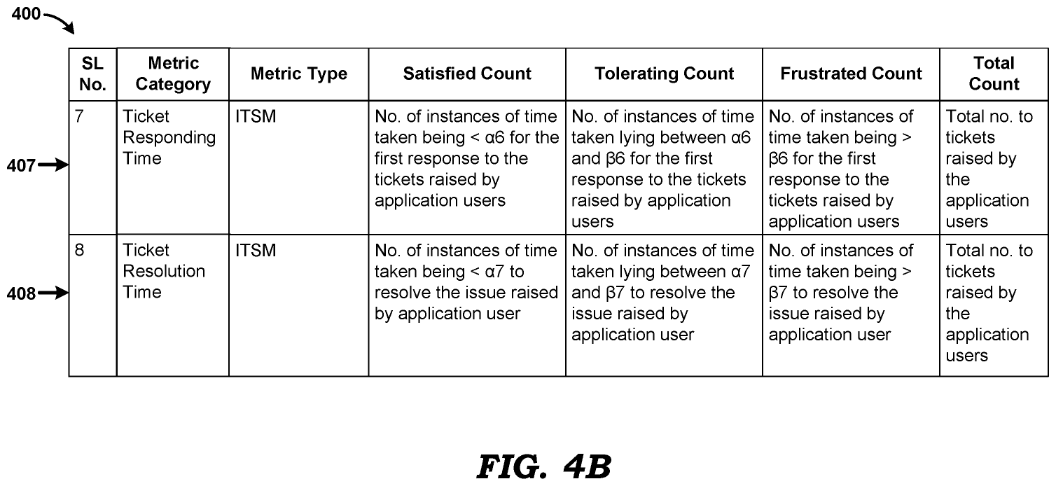

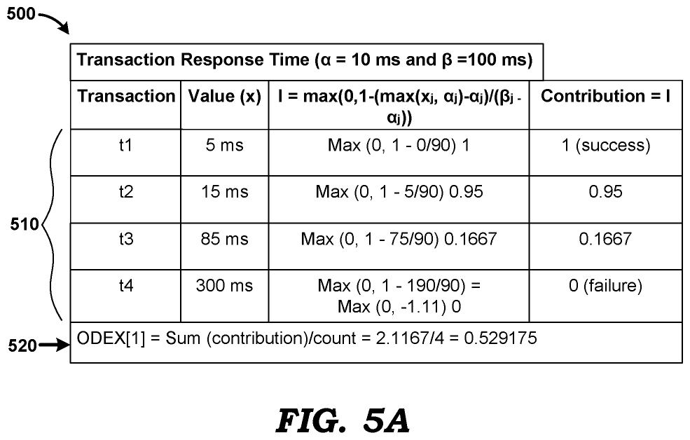

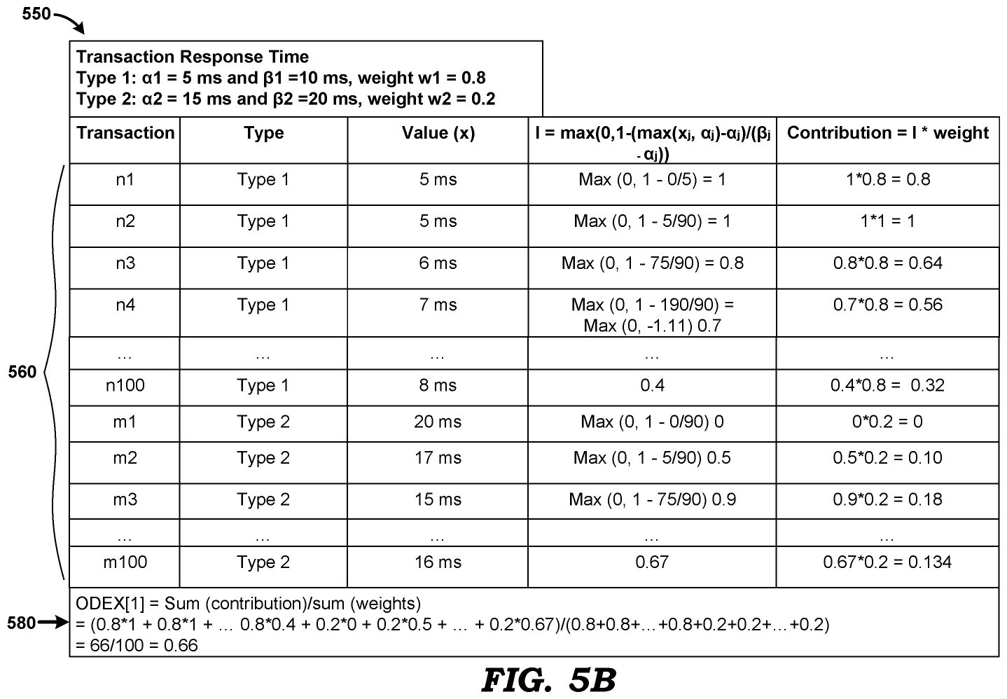

FIGS. 3A-3D, 4A-4B and 5A-5B together illustrate the manner in which user-impact index for applications (deployed in computing environment 135) serving users (using end user systems 110) is computed in one embodiment. Broadly, FIGS. 3A-3D illustrate the manner in which software applications are hosted in a computing infrastructure (130), FIGS. 4A-4B depict the various metrices based on which a user impact index is calculated and FIGS. 5A-5B illustrate example calculations performed for calculating a user impact index. Each of the Figures is described in detail below.

FIG. 3A depicts the components of a software application in one embodiment. For illustration, the software application is assumed to be an online travel application that enables users to search and book both flights and hotels. The online travel application is shown containing multiple components such as portals 311-312 (travel web and payment web respectively), internal/application services 321-324 (flights, hotels, payments and booking respectively) and data stores 331-333 (flights inventory, hotels inventory and bookings DB respectively). It may be appreciated that a software application may contain less or more components, differing in number and type, depending on the implementation of the software application.

Each of portals 311 and 312 represents a software component that is designed to process user requests received from external systems (such as end-user systems 110) connected to Internet 120 and send corresponding responses to the requests. For example, Travel Web portal 311 may receive (via path 122) user requests from a user using end-user system 110-2, process the received user requests by invoking one or more internal/application services (such as 321-323), and the results of processing as corresponding responses to end-user systems 110-2. The responses may include appropriate user interfaces for display in the requesting end-user system (110-2). Payment Web portal 312 may similarly interact with end-user systems 110 and facilitate the user to make online payments.

Each of services 321-324 represents a software component that implements corresponding functionalities of the software application. Example of services are Flights service 331 providing the functionality of search of flights, Hotels service 322 providing the functionality of search of hotels, etc. A service (e.g., Flights service 321) may access/invoke other services (e.g., Booking service 324) and/or data stores (e.g., Flights Inventory 331) for providing the corresponding functionality.

Each of data stores 331-333 represents a storage component that maintains data used by other components of the software application. As noted above, each of the data stores may be implemented as a database server or file system based on the implementation of the software application.

The manner in which the various components of the software application (online travel application) is hosted in a cloud/computing infrastructure 130 is described below with examples.

In one embodiment, virtual machines (VMs) form the basis for executing various software applications in processing nodes/server systems of cloud infrastructure 130. As is well known, a virtual machine may be viewed as a container in which software applications (or components thereof) are executed. A processing node/server system can host multiple virtual machines, and the virtual machines provide a view of a complete machine (computer system) to the enterprise applications executing in the virtual machine. Thus, when multiple VMs are hosted on a single node, the resources (of the node) are shared by the VMs.

FIG. 3B illustrates an example state of a node in a cloud infrastructure. Node 160-1 is shown hosting VMs 341, 342, and 343, with the resources of the node shown allocated among the three VMs and some resources shown as still remaining ‘unused’ (i.e., not provisioned for any execution entity within node 160-1). Some of VMs 341 and 342 is shown hosting guest (modules) 345 and 346. Guest modules 321/322 may correspond to one of software components (such as 311-312, 321-324 and 331-333) of the software application deployed in cloud infrastructure 130. Similarly, other VMs may be hosted in the other nodes of cloud infrastructure 130 and form the basis for deploying other software applications.

It may be appreciated that each of nodes 160 has a fixed number of resources such as memory (RAM), CPU (central processing unit) cycles, persistent storage, etc. that can be allocated to (and accordingly used by) software applications (or components thereof) executing in the node. Other resources that may also be provided associated with the computing infrastructure (but not specific to a node) include public IP (Internet Protocol) addresses, etc. In addition to such infrastructure resources, application resources such as database connections, application threads, etc. may also be allocated to (and accordingly used by) the software applications (or components thereof).

In one embodiment, a cloud for a customer/tenant is provisioned (created) by allocating a desired number of VMs hosted on nodes 160 in cloud infrastructure 130. The manner in which multiple clouds are provisioned in cloud infrastructure 130 is described below with examples.

FIG. 3C illustrates the manner in which multiple clouds (and correspondingly software applications) are hosted in a cloud infrastructure in one embodiment. Specifically, cloud infrastructure 130 is shown hosting clouds 350, 355 and 360. Cloud 350 is shown containing VMs 350-1 through 350-G (G representing any natural number) that may be provisioned on the different nodes 160 of cloud infrastructure 130.

Similarly, clouds 355 and 360 are shown respectively containing VMs 355-1 through 355-H and 360-1 through 360-M (H and M representing any natural number). For illustration, it is assumed that each cloud (350, 355 and 360) hosts a corresponding software application (including multiple instances of the software components). The manner in which components of a software application are deployed in a corresponding cloud (350, 355, and 360) is described below with examples.

FIG. 3D depicts the manner in which components of a software application are deployed in a cloud in one embodiment. In particular, the Figure depicts the manner in which the components of an online travel application shown in FIG. 3A are deployed in cloud 350 of FIG. 3C. For illustration, it is assumed that the components are deployed in eight VMs (i.e., G=8) provisioned as part of cloud 350.

Some of the components are shown having multiple instances, each instance representing a separate execution of the component. Such multiple instances may be necessitated for load balancing, throughput performance, etc. as is well known. Each instance (indicated by the suffix P, Q, R, etc.) is shown hosted and executing in a corresponding VM provisioned on nodes 160 of cloud infrastructure 130. For example, portal 311 is shown having two instances 311P and 311Q deployed on VM 350-4 of cloud 350.

Thus, a software application (online travel application) is hosted in cloud 350/computing infrastructure 130. During operation of the online travel application, a user using end-user system 110-2, may send various user requests for desired tasks such as searching for flights, selecting a flight (from a results of the search), booking a selected flight, etc. The processing of these user requests causes various software components to be invoked, which in turn may cause storage components to be accessed.

Thus, users using end user systems 110 are impacted by various aspects such as availability of computing power, storage capacity, network bottlenecks, etc. (in general, resources) in addition to factors such as design flaws and application crashes, etc. which are identified by PM system 170 and raised as problem tickets in ITSM tool 180. Accordingly, there is a requirement to provide a numerical/quantifying understanding of the extent of impact of such aspects to users of software applications such as the online travel application.

According to an aspect, index determiner 150 computes and provides a single number as a user impact index for a software application (here, the online travel application), with the single number measuring both the responsiveness of the application when processing user requests and the responsiveness to resolution of problems identified in the application. The manner in which the user impact index/single number is calculated in described below with examples.

### 6. Calculating User Impact Index

Broadly, the user impact index is measured along 2 dimensions namely (A) Core Product and (B) Customer Commitment. Across both dimensions, evaluation metrics are defined having satisfaction and frustration thresholds. The user impact index is defined in a way such that if the value of the metric is above the satisfaction threshold the index value is 1, if it is higher than frustrating thresholds it will be 0. For all other values the index value will lie between 0 and 1.

FIGS. 4A and 4B together depicts the various metrices based on which a user impact index is computed according to several aspects of the present disclosure. Though shown in the form of a table, the metrics may be collected/maintained according to other data formats (such as extensible markup language (XML), etc.) and/or using other data structures (such as lists, trees, etc.), as will be apparent to one skilled in the relevant arts by reading the disclosure herein.

Table 400 depicts the responsiveness metrics that measure the responsiveness of the application when processing user requests in rows 401-406 and the problem resolution metrics in rows 407-408. The 8 metrics shown in table 400 are measured, and each transaction (of the total count column) is classified into one of three buckets/classifications—satisfied, tolerating and frustrated, depending on two respective parameters alpha (α) and beta (β) as noted in table 400.

Specifically, parameters alpha (α) represents a lower threshold, below which a value for the metric is classified as a satisfied count, the beta (β) represents an upper threshold above which a value for the metric is classified as a frustrated count. A value for the metric above the alpha and below the beta is classified as a tolerating count. After classifying the values for a metric into a satisfied count, a tolerating count and a frustrated count, a weighted average of the aggregate counts in each classification is generated.

According to one approach, for each of the eight metrics noted in table 400, a corresponding metric-impact index (M_index) is generated according to the formula:

$$M\_index [ i ] = \frac{\begin{matrix}1 * ( Satisfied Counts ) + \\ 0.5 * ( Tolerating Counts ) + 0 * ( Frustrated Counts )\end{matrix}}{Total Counts} \qquad Eq 1$$

Where 1, 0.5 and 0 represent the respective weights sought to be assigned for the satisfied, tolerating, and frustrated experiences. However, different desired weights can be assigned to the three buckets. to arrive at the M_index for the corresponding metric.

A weighted average of the eight metric-index values can be computed to generate a single number representing the desired user-impact index. In case of equal weights (for the different metrics), the impact index may be computed using simple arithmetic mean as follows:

$$A = \frac{1}{n} {\sum }_{i = 1}^{n} {a}_{i} = \frac{{a}_{1} + {a}_{2} + … + {a}_{n}}{n} \qquad Eq 2$$

Wherein A is the user-impact index for an application (online travel application), n=8, and a1, a2, etc., respectively represent M_index[1], M_index[2], etc. computed using Equation 1 noted above.

It may be appreciated that while the discrete classification of each metric value into one of the three buckets may provide a reasonable representation of user impact, it may be desirable to provide a more accurate representation of the user impact. Accordingly, an alternative approach uses a more continuous approach to generate a more accurate impact index as described below with examples.

### 7. Calculating Based on a Continuous Scale of Divergence from Acceptable Metrics

In one embodiment, the user impact index is instead designed to capture the extent of deviation from satisfactory responsiveness for each less-than-satisfactory responsiveness on a continuous scale. For each metric sought to be measured, two corresponding parameters alpha and beta are enabled to be specified, with alpha specifying a threshold, below which a responsiveness is considered completely satisfactory. On the other hand, beta specifies an upper threshold, responsiveness beyond which the system is deemed to be completely unsatisfactory (deemed to be inoperative, even if responses are received).

According to one approach, for each of the eight metrics noted in table 400, a corresponding observability index (ODEX[i]) is computed according to the below formula:

$$ODEX [ i ] = \frac{\sum {w}_{j} * max ( 0 , 1 - ( max ( {x}_{j} , {α}_{j} ) - {α}_{j} ) / ( {β}_{j} - {α}_{j} ) )}{\sum {w}_{j}} \qquad Equation 3$$

If all transactions are assumed to have same weight this formula reduces to:

$$ODEX [ i ] = \frac{1}{N} \sum max ( 0 , 1 - ( max ( {x}_{j} , {α}_{j} ) - {α}_{j} ) / ( {β}_{j} - {α}_{j} ) ) \qquad Equation 4$$

Within each measured metric i, the relative importance of the various transaction types corresponding to different kinds of transactions, tickets, etc., could be incorporated by using weighted counts as follows:

Weighted Counts=Σwⱼ*Nⱼ

where wⱼ is the weight and Nⱼ is the count (satisfied/tolerating/frustrated/total) for entity type j.

This formula is used to calculate the individual score for each metric. The summation is over the total number of instances for that particular metric type. For example, if the metric is Transaction Response Time (row 301) we get individual response times for each transaction instance for each type. So, if there are N transaction types and n1 instances of type t1, n2 instances of type t2, etc. then index determiner 150 sums over all n1 instances of t1 to get score for transaction t1 (here Equation 4 is used) and similarly for all transaction types. After that, index determiner 150 takes a weighted average of the scores for each transaction type using the instance count as weights given by Equation 3.

FIGS. 5A-5B illustrate example calculations performed for calculating a user impact index for an application (online travel portal). In FIG. 5A, table 500 depicts the calculations performed for the responsiveness metric “Transaction Response Time” (i=1 as per the serial no. in table 400) when all the values for the metric have equal weightage (assumed to be 1 for illustration). The calculations are shown assuming that the parameters alpha (α) and beta (β) have been set to the values 10 ms (millisecond) and 100 ms respectively.

Rows 510 indicate the calculations performed for different values of the responsiveness metric. It may be observed that each value of the metric contributes a value between 0 to 1 towards the computation of the observability index. For example, for transaction t3, the contribution is 0.1667. The observability index ODEX[1] is then calculated as the average of the contributions from the different transactions/metric values as shown in row 520.

It may be appreciated that transactions of certain types may be given higher/different weights as noted above. In the case of core product metrics (rows 401-406), weights based on the relative usage of the corresponding metric may be used. For example, if Transaction 1 happens 100 times and Transaction 2 50 times in the same interval (time duration), Transaction 1 may be assigned double the weight of Transaction 2. For customer commitment metrics (rows 407-408), the weights may be assigned equivalent to the severity of the corresponding tickets. The weights may be assigned based on the priority/severity of each problem ticket as well as the count.

Turning to FIG. 5B, table 550 depicts the calculations performed for the responsiveness metric “Transaction Response Time” (i=1 as per the serial no. in table 400) when the values for the metric have different weightages. For illustration, it is assumed that there are two different weightages (0.8 and 0.2) associated with two different transaction types (Type 1 and Type 2). In addition, each transaction type is associated with corresponding values for the parameters alpha (α) and beta (β).

Rows 560 indicate the calculations performed for different values of the responsiveness metric. In addition to the value, each transaction is shown associated with a corresponding type, and accordingly the calculation of the intermediate value (I) is determined based on the alpha and beta values for the corresponding transaction type. It may be observed that each value of the metric contributes now a value which is a product of the weightage associated with transaction type and the intermediate value I. Assuming that there are 100 transaction of Type 1 and 100 transactions of Type 2, the observability index ODEX[1] is computed as sum (contributions)/sum(weights)=(0.8*1+0.8*1+ . . . 0.8*0.4+0.2*0+0.2*0.5+ . . . +0.2*0.67)/0.8+0.8+ . . . +0.8+0.2+0.2+ . . . +0.2=0.66 as shown in row 580.

Thus, index determiner 150 computes the observability index of a measured metric. Similar computations may be performed based on the values of the other metrics to determine the observability indexes for each of the 8 rows in table 400. After computing the metric indexes, an effective score for each of the dimensions is computed as below:

ODEX_{core}=f(ODEX[1],ODEX[2],ODEX[3],ODEX[4],ODEX[5],ODEX[6])

ODEXₛᵤₚₚₒᵣₜ=f(ODEX[7],ODEX[8])

### Where

ODEX_{core} is the Core Product Impact Index and is the effective ODEX score for dimension (A) Core Product;
ODEXₛᵤₚₚₒᵣₜ is the Customer Commitment Index and is the effective ODEX score for dimension (B) Customer Commitment;
f is a function representing the averaging scheme to be employed; and
ODEX[i] is the score computed for the corresponding metric.

In one embodiment, f is chosen to be simple arithmetic mean as follows:

$$A = \frac{1}{n} {\sum }_{i = 1}^{n} {a}_{i} = \frac{{a}_{1} + {a}_{2} + … + {a}_{n}}{n}$$

For example, if ODEX[7]=0.8 and ODEX[8]=0.5, ODEXₛᵤₚₚₒᵣₜ=(0.8+0.5)/2=0.65.

After computing the ODEX_{core} and ODEXₛᵤₚₚₒᵣₜ, index determiner 150 computing said single number as a second function (g) of said core product impact index and said customer commitment index. In one embodiment, the second function g is chosen to be the harmonic mean. Accordingly, the user impact index (S) is calculated by:

$$S = 1 - Harmonic Mean ( {ODEX}_{core} , {ODEX}_{support} ) = 1 - \frac{2}{\frac{1}{{ODEX}_{core}} + \frac{1}{{ODEX}_{support}}}$$

For example, if the ODEX_{core}=0.9 and ODEXₛᵤₚₚₒᵣₜ=0.2, the user impact index is computed as 1−2/(1/0.9+1/0.2)=1−0.327=0.673.

Thus, index determiner 150 computes and provides a single number as a user impact index for a software application (here, the online travel application), with the single number measuring both responsiveness of the application when processing user requests and the responsiveness to resolution of problems identified in the application.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

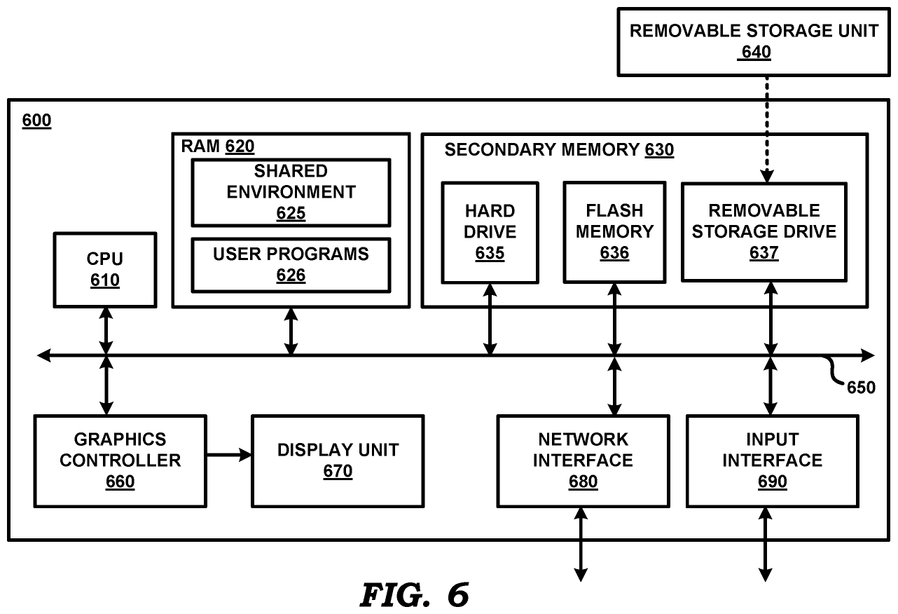

FIG. 6 is a block diagram illustrating the details of digital processing system (800) in which various aspects of the present disclosure are operative by execution of appropriate executable modules. Digital processing system 600 may correspond to index determiner 150 or any system implementing index determiner 150.

Digital processing system 600 may contain one or more processors such as a central processing unit (CPU) 610, random access memory (RAM) 620, secondary memory 630, graphics controller 660, display unit 670, network interface 680, and input interface 690. All the components except display unit 670 may communicate with each other over communication path 650, which may contain several buses as is well known in the relevant arts. The components of FIG. 6 are described below in further detail.

CPU 610 may execute instructions stored in RAM 620 to provide several features of the present disclosure. CPU 610 may contain multiple processing units, with each processing unit potentially being designed for a specific task. Alternatively, CPU 610 may contain only a single general-purpose processing unit.

RAM 620 may receive instructions from secondary memory 630 using communication path 650. RAM 620 is shown currently containing software instructions constituting shared environment 625 and/or other user programs 626 (such as other applications, DBMS, etc.). In addition to shared environment 625, RAM 620 may contain other software programs such as device drivers, virtual machines, etc., which provide a (common) run time environment for execution of other/user programs.

Graphics controller 660 generates display signals (e.g., in RGB format) to display unit 670 based on data/instructions received from CPU 610. Display unit 670 contains a display screen to display the images defined by the display signals. Input interface 690 may correspond to a keyboard and a pointing device (e.g., touch-pad, mouse) and may be used to provide inputs. Network interface 680 provides connectivity to a network (e.g., using Internet Protocol), and may be used to communicate with other systems connected to the networks.

Secondary memory 630 may contain hard drive 635, flash memory 636, and removable storage drive 637. Secondary memory 630 may store the data (e.g., data shown in FIGS. 5A-5B, the values of alpha, beta, calculated intermediate values, final index values) and software instructions (e.g., for performing the actions of FIG. 2, for implementing the various aspects of the present disclosure), which enable digital processing system 600 to provide several features in accordance with the present disclosure. The code/instructions stored in secondary memory 630 may either be copied to RAM 620 prior to execution by CPU 610 for higher execution speeds, or may be directly executed by CPU 610.

Some or all of the data and instructions may be provided on removable storage unit 640, and the data and instructions may be read and provided by removable storage drive 637 to CPU 610. Removable storage unit 640 may be implemented using medium and storage format compatible with removable storage drive 637 such that removable storage drive 637 can read the data and instructions. Thus, removable storage unit 640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 640 or hard disk installed in hard drive 635. These computer program products are means for providing software to digital processing system 600. CPU 610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 630. Volatile media includes dynamic memory, such as RAM 620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A non-transitory machine-readable medium storing one or more sequences of instructions, wherein execution of said one or more instructions by one or more processors contained in a digital processing system cause said digital processing system to perform the actions of:
measuring a plurality of metrics of an application, wherein a first metric of said plurality of metrics represents a measure of the responsiveness of said application when processing user requests received from users, wherein a second metric of said plurality of metrics represents a measure of the responsiveness to resolution of problems identified in said application;
calculating a single number based on said plurality of metrics including said first metric and said second metric; and
providing said single number as representing a user impact index for said application.

2. The non-transitory machine-readable medium of claim 1, wherein a first value for said user impact index indicates that the extent of impact of said application on said users is most desirable, and a second value for said user impact index indicates that the extent of impact of said application on said users is least desirable, wherein said first value is different significantly from said second value with intermediate values reflecting corresponding degree of desirability of impact.

3. The non-transitory machine-readable medium of claim 2, wherein said calculating calculates said single number to be close to said first value when both the responsiveness of said application when processing user requests and the responsiveness to resolution of problems are high,
wherein said calculating calculates said single number to be close to said second value when both the responsiveness of said application when processing user requests and the responsiveness to resolution of problems are low.

4. The non-transitory machine-readable medium of claim 3, wherein said plurality of metrics includes responsiveness metrics comprising said first metric and problem resolution metrics comprising said second metric, said calculating comprises:
quantifying each metric of said plurality of metrics by a respective observability index;
determining a core product impact index as a first function of said respective observability index for responsiveness metrics in said plurality of metrics, and a customer commitment index as said first function of said respective observability index for problem resolution metrics in said plurality of metrics; and
computing said single number as a second function of said core product impact index and said customer commitment index.

5. The non-transitory machine-readable medium of claim 4, wherein said first function is arithmetic mean and said second function is harmonic mean.

6. The non-transitory machine-readable medium of claim 4, wherein said quantifying each metric uses a continuous function of the weighted values of the metric,
wherein the weights for a responsiveness metric are ratios of the number of transactions of a transaction type of a value to the total number of transactions in a fixed duration,
wherein the weights for a problem resolution metric represent one or both of a priority and a severity of a problem identified in said application.

7. The non-transitory machine-readable medium of claim 6, further comprising specifying parameters alpha and beta for each metric, wherein alpha represents a lower threshold below which a value for said metric is considered completely satisfactory, wherein beta represents an upper threshold above which a value for said metric is considered completely unsatisfactory,
wherein said quantifying uses the equation:
$$ODEX [ i ] = \frac{\sum {w}_{j} * max ( 0 , 1 - ( max ( {x}_{j} , {α}_{j} ) - {α}_{j} ) / ( {β}_{j} - {α}_{j} ) )}{\sum {w}_{j}}$$
where
ODEX[i] is the observability index for the i th metric,
xj is the j th value measured for the i th metric,
aj is the alpha parameter for the j th value of the i th metric,
bj is the beta parameter for the j th value of the i th metric,
wj is the weight associated with the j th value.

8. The non-transitory machine-readable medium of claim 7, wherein the responsiveness metrics include transaction response time of said application, availability of said application, screen rendering time, page loading time, application crashes, and start-up times of said application,
wherein the problem resolution metrics include time to respond to a problem ticket raised by a user, and resolution time of a problem ticket.

9. A method comprising:
measuring a plurality of metrics of an application, wherein a first metric of said plurality of metrics represents a measure of the responsiveness of said application when processing user requests received from users, wherein a second metric of said plurality of metrics represents a measure of the responsiveness to resolution of problems identified in said application;
calculating a single number based on said plurality of metrics including said first metric and said second metric; and
providing said single number as representing a user impact index for said application.

10. The method of claim 9, wherein a first value for said user impact index indicates that the extent of impact of said application on said users is most desirable, and a second value for said user impact index indicates that the extent of impact of said application on said users is least desirable, wherein said first value is different significantly from said second value with intermediate values reflecting corresponding degree of desirability of impact.

11. The method of claim 10, wherein said calculating calculates said single number to be close to said first value when both the responsiveness of said application when processing user requests and the responsiveness to resolution of problems are high,
wherein said calculating calculates said single number to be close to said second value when both the responsiveness of said application when processing user requests and the responsiveness to resolution of problems are low.

12. The method of claim 11, wherein said plurality of metrics includes responsiveness metrics comprising said first metric and problem resolution metrics comprising said second metric, said calculating comprises:
quantifying each metric of said plurality of metrics by a respective observability index;
determining a core product impact index as a first function of said respective observability index for responsiveness metrics in said plurality of metrics, and a customer commitment index as said first function of said respective observability index for problem resolution metrics in said plurality of metrics; and
computing said single number as a second function of said core product impact index and said customer commitment index,
wherein said first function is arithmetic mean and said second function is harmonic mean.

13. The method of claim 12, wherein said quantifying each metric uses a continuous function of the weighted values of the metric,
wherein the weights for a responsiveness metric are ratios of the number of transactions of a transaction type of a value to the total number of transactions in a fixed duration,
wherein the weights for a problem resolution metric represent one or both of a priority and a severity of a problem identified in said application.

14. The method of claim 13, wherein the responsiveness metrics include transaction response time of said application, availability of said application, screen rendering time, page loading time, application crashes, and start-up times of said application,
wherein the problem resolution metrics include time to respond to a problem ticket raised by a user, and resolution time of a problem ticket.

15. A digital processing system comprising:
a random access memory (RAM) to store instructions for recommending remediation actions; and
one or more processors to retrieve and execute the instructions, wherein execution of the instructions causes the digital processing system to perform the actions of:
measuring a plurality of metrics of an application, wherein a first metric of said plurality of metrics represents a measure of the responsiveness of said application when processing user requests received from users, wherein a second metric of said plurality of metrics represents a measure of the responsiveness to resolution of problems identified in said application;
calculating a single number based on said plurality of metrics including said first metric and said second metric; and
providing said single number as representing a user impact index for said application.

16. The digital processing system of claim 15, wherein a first value for said user impact index indicates that the extent of impact of said application on said users is most desirable, and a second value for said user impact index indicates that the extent of impact of said application on said users is least desirable, wherein said first value is different significantly from said second value with intermediate values reflecting corresponding degree of desirability of impact.

17. The digital processing system of claim 16, said digital processing system calculates said single number to be close to said first value when both the responsiveness of said application when processing user requests and the responsiveness to resolution of problems are high,
wherein said digital processing system calculates said single number to be close to said second value when both the responsiveness of said application when processing user requests and the responsiveness to resolution of problems are low.

18. The digital processing system of claim 17, wherein said plurality of metrics includes responsiveness metrics comprising said first metric and problem resolution metrics comprising said second metric, when for said calculating, said digital processing system performs the actions of:
quantifying each metric of said plurality of metrics by a respective observability index;
determining a core product impact index as a first function of said respective observability index for responsiveness metrics in said plurality of metrics, and a customer commitment index as said first function of said respective observability index for problem resolution metrics in said plurality of metrics; and
computing said single number as a second function of said core product impact index and said customer commitment index,
wherein said first function is arithmetic mean and said second function is harmonic mean.

19. The digital processing system of claim 18, wherein said quantifying each metric uses a continuous function of the weighted values of the metric,
wherein the weights for a responsiveness metric are ratios of the number of transactions of a transaction type of a value to the total number of transactions in a fixed duration,
wherein the weights for a problem resolution metric represent one or both of a priority and a severity of a problem identified in said application.

20. The digital processing system of claim 19, wherein the responsiveness metrics include transaction response time of said application, availability of said application, screen rendering time, page loading time, application crashes, and start-up times of said application,
wherein the problem resolution metrics include time to respond to a problem ticket raised by a user, and resolution time of a problem ticket.
